(19) United States
(12) Patent Application Publication
(10) Pub. No.: US 2024/0030484 A1
(43) Pub. Date: Jan. 25, 2024

(54) SODIUM-ION BATTERY CATHODE MATERIAL

(71) Applicant: Worcester Polytechnic Institute, Worcester, MA (US)

(72) Inventors: Panawan Vanaphuti, Worcester, MA (US); Yan Wang, Acton, MA (US)

(21) Appl. No.: 18/223,376

(22) Filed: Jul. 18, 2023

Related U.S. Application Data
(60) Provisional application No. 63/390,495, filed on Jul. 19, 2022.

(51) Int. Cl. H01M 10/054; H01M 4/04

(52) U.S. Cl. CPC H01M 10/054; H01M 4/0471; H01M 2004/028

(57) ABSTRACT

A sodium-ion batteries (NIBs) employs doped P2-type phase using novel Na—Mn-Li—O oxide composition with different ions to alleviate the structural deterioration and enhance the electrochemical performance at high voltage. A sodium-ion battery (NIB) exhibits a stoichiometric ratio of sodium, manganese and lithium for a battery cathode, combined and agitated to form a granular mixture in the determined stoichiometric ratio. A doping element is added to the granular mixture, and the granular mixture sintered for a predetermined time and temperature for forming an NIB battery cathode material.

### RELATED APPLICATIONS

This patent application claims the benefit under 35 U.S.C. § 119(e) of U.S. Provisional Patent App. No. 63/390,495, filed Jul. 19, 2022, entitled “SODIUM-ION BATTERY CATHODE MATERIAL,” incorporated herein by reference in entirety.

### BACKGROUND

Li-ion batteries (LIB s) have been widely applied in recent decades, particularly with respect to electric vehicles (EV) and plug-in electric vehicles (PHEV) which have been equipped with or directly powered by LIBs. LIBs have been widely used in portable electronics, electric vehicles and grid storage as dominant power sources. Costs of raw materials in mining and refining lithium and other metals used for charge materials, such as Ni, Mn and Co, have driven a demand for more readily available battery cathode materials.

### SUMMARY

A method for producing sodium-ion batteries (NIBs) employs doped P2-type phase using novel Na—Mn-Li—O oxide composition with different ions to alleviate the structural deterioration and enhance the electrochemical performance at high voltage. Configurations herein demonstrate NIBs at a low cost due to abundant and environmentally benign elements without the needs of Co and Ni as in most conventional cathode materials.

Batteries for electric and hybrid vehicles have typically been formed from cathode materials including cathode material metals, including lithium, and anode materials, such as carbon or graphite. Configurations herein are based, in part, on the observation that nickel, manganese and cobalt (NMC) are often combined with lithium to form a cathode material for a Li-ion battery. Unfortunately, conventional approaches to EV (electric vehicle) batteries suffer from the shortcoming that typical cathode material metals are nickel, manganese, cobalt and aluminum, and procurement can involve expensive mining, refining and transport costs. Accordingly, configurations herein substantially overcome the shortcomings of LIBs by providing a sodium ion (Na-ion) battery (NIB). Despite the dominance of lithium-ion batteries (LIBs), sodium-ion batteries (NIBs) are becoming more attractive in recent years owing to their low cost, abundance of sodium ions in the earth crust, environmental compatibility, and similar mechanism to LIB s.

Configurations herein demonstrate a method of forming a sodium-ion battery (NIB) by determining a stoichiometric ratio of sodium, manganese and lithium for a battery cathode, and combining and agitating the sodium, manganese and lithium to form a granular mixture in the determined stoichiometric ratio. A doping element is added to the granular mixture, and the granular mixture sintered for a predetermined time and temperature for forming a cathode material.

In the disclosed approach, a method for generating a secondary (rechargeable) battery includes determining a stoichiometric ratio for a cathode material, and combining Na₂CO₃, Mn₂O₃ and LiOH·H₂O powders based on the stoichiometric ratio to provide an efficient cost and performance. Lithium hydroxide monohydrate is an inorganic compound (LiOH·H₂O), which is typically in the form of a white crystalline powder and is strongly alkaline. Battery-grade lithium hydroxide is mainly used to produce the cathode material of high-energy lithium-ion batteries for applications such as electric vehicles, electric bicycles, power tools, and energy storage systems.

The combined powders are mixed, such as with an agate mortar and pestle. to form a precursor mixture. The precursor mixture is sintered at around 800° C. for 14 hours under an air atmosphere while heating and cooling at a rate of 2° C. min⁻¹ to induce a solid-state reaction. Additional features include doping the mixture using materials based on a similarity to Mn, therefore providing increased performance while using more readily available raw cathode materials.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A-F shows morphology images of sodium ion batteries (NIB), including Si and Ti doping;

FIG. 2 shows X-ray powder diffraction (XRD) patterns;

FIG. 3 shows a layered structure of a P2 cathode;

FIGS. 4A-4C show a Rietveld refinement profile of PR, 1Ti, and 1Si;

FIG. 5 shows a percentage of half-cell capacity retention during 150 cycles for each sample of PR, 1Ti and 1Si; and

FIG. 6 shows voltage retention for PR (Pristine Material), 1Ti, and 1Si.

### DETAILED DESCRIPTION

In configurations depicted below, example configurations of NIBs are shown, including doping with elements such as Si and Ti. P2-type sodium-manganese-based layered cathodes, owing to their high capacity from both cationic and anionic redox, are a potential candidate for Na-ion batteries (NIBs) to replace Li-ion technology in certain applications. Still, the structure instability originating from irreversible oxygen redox at high voltage remains a challenge. Here, a high sustainability cobalt-free P2-Na_{0.72}Mn_{0.75}Li_{0.24}X_{0.01}O₂ (X═Ti/Si) cathode is developed. The outstanding capacity retention and voltage retention after 150 cycles are obtained in half-cells. The finding shows that Ti localizes on the surface while Si diffuses to the bulk of the particles. Thus, Ti can act as a protective layer that alleviates side reactions in carbonate-based electrolyte. Meanwhile, Si can regulate the local electronic structure and suppress oxygen redox activities. Notably, full-cells with hard carbon (300-335 W h kg⁻¹ based on the cathode mass) deliver the capacity retention of 83% for P2-Na_{0.72}Mn_{0.75}Li_{0.24}Si_{0.01}O₂ and 66% for P2-Na_{0.72}Mn_{0.75}Li_{0.24}Ti_{0.01}O₂ after 500 cycles; this electrochemical stability is the best compared to other reported cathodes based on oxygen redox at present. The superior cycle performance also stems from the ability to inhibit microcracking and planar gliding within the particles. Altogether, this improvement offers a new composition for developing high-performance low-cost cathodes for NIBs and highlights the unique role of Ti/Si ions.

Encouraged by the successful commercialization of Li-ion batteries (LIBs), many recent interests have been drawn toward NIBs as an alternative for next-generation energy storage devices. Due to the concern of high price and availability limitations for Li and Co in recent years, the use of NIBs becomes more appealing considering their advantages including low cost, being environmentally benign, having a similarity to LIBs mechanism and manufacturing, and elemental abundance of Na in the earth crust. Multiple Na-ion cathodes have been extensively studied to meet the growing market demands and practical applications such as Prussian blue, polyanionic compounds, and layered transition metal oxides.

Among various types of NIBs cathode materials, Mn-based layered oxides, specifically so-called P2 and O3-type are promising candidates owing to their low cost, variable compositions, suitable Na-ion diffusion pathway, wide operating voltage, and high energy density. The differences between the two are the stoichiometric ratio of Na and the stacking arrangement of Na atoms versus transition-metal (TM) layers (2 Na-ions in prismatic sites for P2 and 3 Na-ions in octahedral sites for O3), which have a great influence on the redox capability. Evolution of sodium-ion cathodes is as follows. P2-type Na cathodes were first introduced with the composition of Na_{0.70}MnO_{2.25}. Later, well-known Na-deficient P2-types were developed with compositions of Na_{0.67}Mn_{0.67}Ni_{0.33}O₂ (reversible capacity of ˜135 mA h g⁻¹ and Na_{0.67}Mn_{0.5}Fe_{0.5}O₂ (reversible capacity ˜190 mA h g⁻¹) between the potential range of 1.5-4.3 V. Meanwhile, the introduction of inert elements such as Li⁺/Mg²⁺/Zn²⁺ and vacancies to the P2 structure (increase O/TM ratio) can favor the formation of the non-bonding O 2p orbitals, where these ions are substituting the TM ions. Thus, high capacity is feasible through the assistance of anionic redox (O2-/O—) beyond 4.3 V.

Recently, studies on Li substitution in Na—Mn—O oxides reveal an attractive specific capacity between 1.5-4.5 V (versus Na/Na⁺) by utilizing unhybridized O 2p anionic redox. P2/O2-type Na_{5/6}[Li_{1/4}Mn_{3/4}]O₂ with a reversible capacity of 200 mA h^{g-1} at upper cut-off voltage of 4.4 V have been introduced. Additionally, it has been reported that P2-type Na_{0.6}Li_{0.2}Mn_{0.8}O₂ can provide ˜190 mA h g⁻¹ after 100 cycles between the voltage of 2.0-4.6 V after the activation process. P2-type Na_{0.72}[Li_{0.24}Mn_{0.76}]O₂, has been shown to have a high initial charge of ˜210 mA h g⁻¹ (2.0-4.5 V), yet the capacity decays rapidly. On the other hand, other types of layered cathode structures have also been explored, such as P3-type Na_{0.6}(Li_{0.2}Mn_{0.8})O₂ and O3-type NaLi_{1/3}Mn_{2/3}O₂ (˜190 mA h g⁻¹). In contrast to the latter configuration, the former is found to have significant voltage decay and irreversible O 2p redox after 50 cycles. Inevitably, the high lattice strain of Na, irreversible oxygen loss, and structural rearrangement induced by the Jahn-Teller distortion of Mn³⁺ deteriorate the structural stability and electrochemical performance. Hence, to tackle these issues, a search for a suitable element to add to Na—Mn-Li—O composition (P2-NMO) is necessary, and modulation of the local substitution for Mn ions is considered one of the most effective ways. Among various elements, tetravalent Si and Ti have several advantages in retaining structural stability due to the strong covalent bonding of Si—O and Ti—O. In fact, partial substitution of inactive Ti in the Na-layered oxides has been shown to have positive outcomes in terms of lessening structure evolution, reducing lattice strain, increasing voltage/capacity retention, and improving reversibility of TM/O migration during sodiation/de-sodiation process. Studies in Li-rich layered oxides have indicated that Si in TM sites can reduce the O 2p band of the Fermi level, promote the formation of oxygen vacancies, and decrease the covalency degree between TM-O allowing greater reversibility of anionic redox. However, conventional approaches have shown no report on the role of Si or Ti as dopants in Na layered oxides.

Configurations herein disclose a P2-Na_{0.72}Mn_{0.75}Li_{0.24}X_{0.01}O₂ (X═Ti/Si) layered oxide synthesized via a facile solid-state reaction. With the addition of Ti/Si, the structural stability is improved significantly with both capacity (˜86-87%) and voltage retention (˜97%) after 150 cycles at 1 C in Na half-cells. Configurations herein demonstrate that Ti prefers to be at the surface while Si diffuses into the bulk. Specifically, Ti enhances the rate capability and Si extends the cycle life. Further analysis also confirms the superior structural integrity, more Mn⁴⁺ on the surface (less structural distortion from the Jahn-Teller effect), diminished microcracking, no planar gliding, and low stacking faults for P2-Na_{0.72}Mn_{0.75}Li_{0.24}Si_{0.01}O₂ (1Si) sample after cycling. The major cause of capacity degradation is believed to stem from the microcracking and planar gliding within the particles. Based on the theoretical calculation, Si can regulate the density of states of the surrounding O atoms; thus, suppresses the irreversible O redox activities. Further, the performance of full coin-cells has the capacity retention of 66% (P2-Na_{0.72}Mn_{0.75}Li_{0.24}Ti_{0.01}O₂ (1Ti)) and 83% (1Si) after 500 cycles at 0.5 C in which the pristine material (P2-Na_{0.72}Mn_{0.76}Li_{0.24}O₂ (PR)) only retains 25% of the initial capacity. The remarkable energy density of 300-335 W h kg-1 based on the cathode mass at 0.5 C can be achieved with 1Ti/1Si samples. In short, this work reveals a novel and low-cost P2-type composition as high-energy-density cathode materials for NIBs.

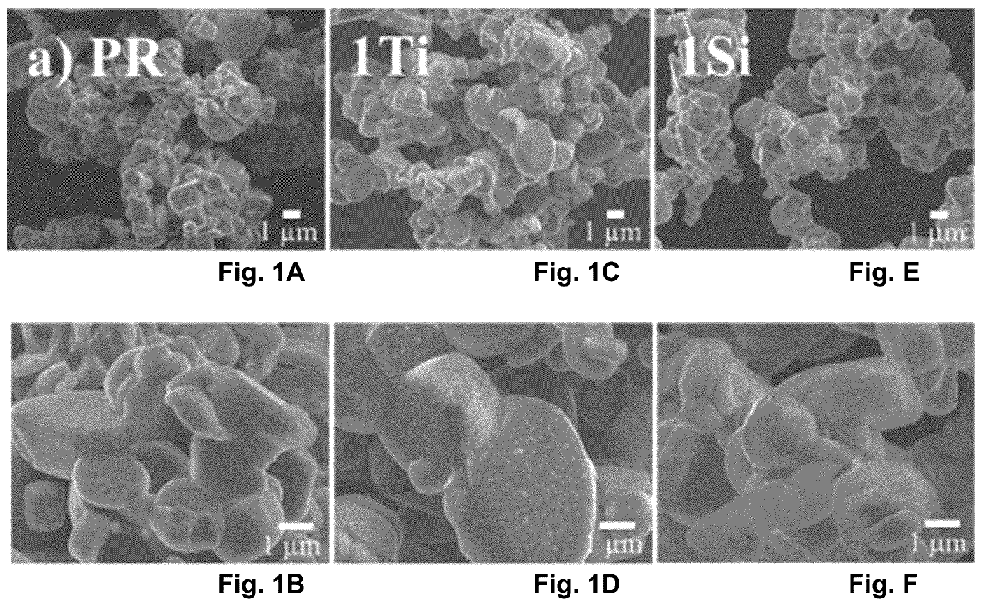

FIG. 1A-F shows morphology images of sodium ion batteries (NIB), including Si and Ti doping. Referring to FIGS. 1A-1F, FIGS. 1A-B show scaled SEM images of PR;

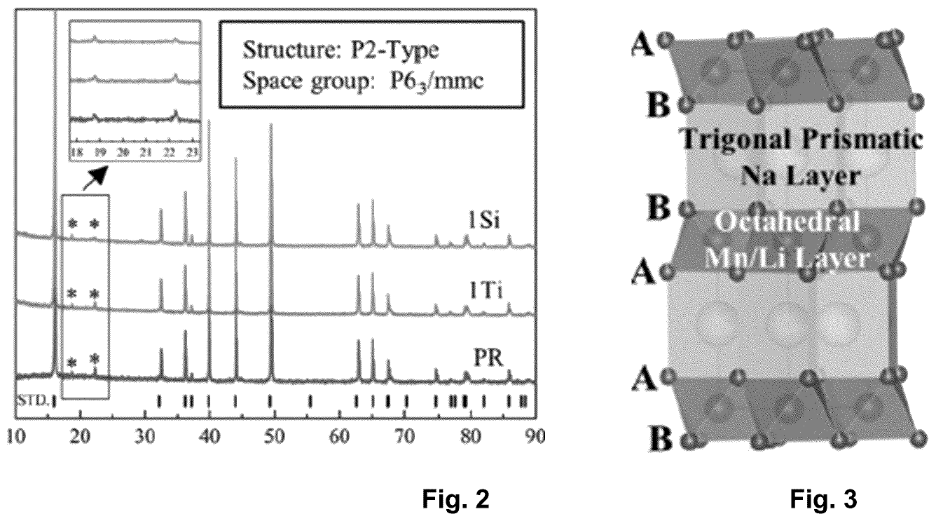

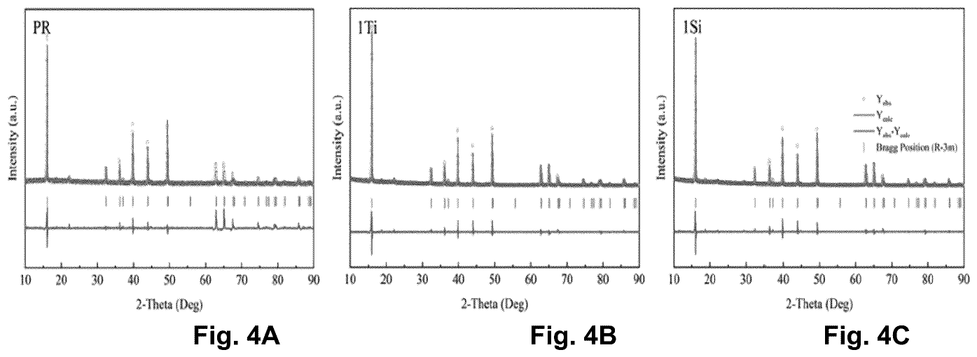

FIGS. 1C-D show 1Ti, and FIGS. 1D-E show 1Si. The morphology of P2-NMO particles shows plate-like structure with an average particle size of 2-4 um. FIG. 2 shows X-ray powder diffraction (XRD) patterns, and FIG. 3 shows a layered structure of a P2 cathode. Referring to FIGS. 2 and 3, from FIG. 2, all X-ray powder diffraction (XRD) patterns are well-matched with P2-type cathodes' structure (FIG. 3) corresponding to ABBA oxygen stacking order with two Na atoms in prismatic sites (space group: P63/mmc). The resulting cathode material therefore exhibits two sodium ions in prismatic sites for forming the P2 layered oxide structure of FIG. 3. In contrast, the small signals around 19-22°, which is different from the pure P2 phase, represent the superstructure ordering of Li/Mn within the TM layer. This is induced by the differences in the ionic radii equal to or greater than 15%. As shown in the inset of FIG. 1b, the 1Ti and 1Si samples have distinct intensity of these peaks compared to PR that ascertains the impact of these ions on the ordering of TM layers even when the amount is only 1 mol. %. The Rietveld refinement in FIGS. 4A-4C of PR, 1Ti and 1Si, respectively, is also computed to further confirm the structural parameters in relation to PR. In general, the c-axis, unit cell volume, and oxygen site at the Z position increase after adding 1 mol. % Ti/Si. Compared to the reference pattern, Ti/Si ions influence the occupancies of Na at the 2d site than 2b site as the refined values show obvious decreases at the 2d site. These can be related to the change in local ordering between Li/Mn layer, which is partially replaced by Ti/Si, causing differences in the electrostatic forces and binding energy within the atomic range.

In the example arrangement, the method of forming a sodium-ion (NIB) battery comprising determining the stoichiometric ratio of sodium, manganese and lithium for a battery cathode as disclosed above, and combining and agitating the sodium, manganese and lithium to form a granular mixture in the determined stoichiometric ratio. The added sodium, manganese and lithium further takes the form of Na₂CO₃, Mn₂O₃ and LiOH·H₂O, respectively, of at least 98% purity. A doping element or compound, such as Ti or Si. is added to the granular mixture; and the granular mixture sintered for a predetermined time and temperature for forming the cathode material for the NIB. The stoichiometric ratio is typically a molar quantity of both sodium and manganese of about twice the molar ratio of lithium, and in some cases has an equal molar quantity of both sodium and manganese, where the molar quantity of sodium and manganese is at least three times the molar quantity of lithium.

The temperature and duration of sintering may be adjusted depending on relevant factors; in a particular example, sintering includes heating at between 700° C. and 900° C. for between 12-16 hours. The molar amounts of the charge material metals, as well as the doping elements, may be varied somewhat. Doping generally includes adding an amount of the doping element in a quantity less than 10%, and optionally less than 2%, of the molar ratio of any of the sodium, manganese and lithium, often substantially less. An example arrangement includes a doping element of Ti or Si in a molar quantity less than 5%, or optionally less than 2%, of the molar quantity of Li.

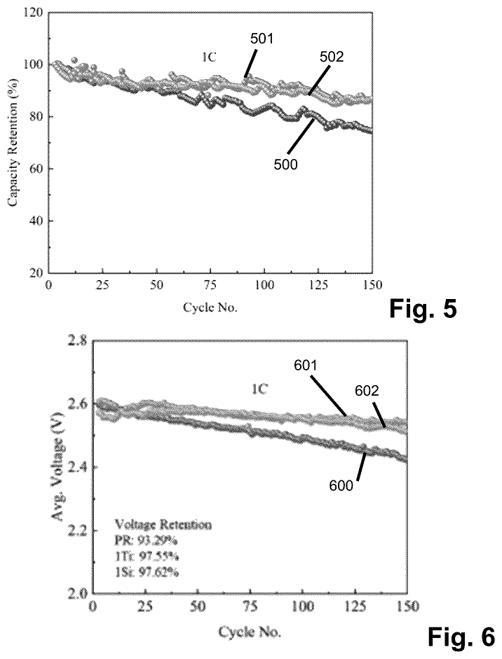

The rate performance of the 1Ti sample indicates better ionic conductivity at a high rate compared to PR. Although PR has ˜1.25 times (250 vs 200 mA h g⁻¹ at 0.1 C) greater specific capacity at a low rate than those of 1Ti and 1Si, the capacity degradation among each rate is more pronounced. At 5 C, both 1Ti and 1Si outperform PR, due to the slight increase of Na slab as revealed by refinement results. Note that 0.5 mol. % and 2 mol. % of Ti/Si have also been systematically examined to determine the optimal dopant ratio and the compositions are confirmed by ICP-MS where there is =<10% acceptable differences between nominal ratio and experimental data caused by the instrument analysis and the dopant amount is relatively small (Table I) In contrast to 1 mol. %, the 0.5 mol. % is too less to obtain good structural stability whereas 2 mol. % of these redox-inactive ions will decrease the specific capacity. In order to avoid a lower specific capacity than PR, only 1 mol. % of Ti/Si has been selected since these ions are electrochemically inactive and do not contribute to the redox reaction. Besides, by adding these dopants, the participation of O anionic redox during the Na intercalation process is much smaller than PR since these ions provide stronger bond strength to O, resulting in a lower overall specific capacity. Referring to FIG. 5, FIG. 5 shows that the cycle stability of 1Ti 501 and 1Si 502 are also maintained at 86.82% and 87.44% at 1 C after 150 cycles between 1.5-4.5, respectively, whereas PR 500 is 74.51%. It is noteworthy that the participation of oxygen redox at high voltage also plays a role to provide additional capacity as shown in previous reports. At high voltage, unfavorable side reactions with electrolyte, and structural transformation due to oxygen redox and Mn/Li migration are inevitable, which lead to performance deterioration of P2-NMO cathodes during prolonged cycles. Referring to FIG. 6, it can be seen that 1Ti 601 and 1Si 602 samples give notable voltage retention of ˜97% after 150 cycles (akin to 93% of PR 600). In fact, 1Ti and 1Si samples do not show any planar gliding or microcracking along with the particles after the cycle where these factors are believed to be the main reason for capacity degradation.

TABLE I

Molar Ratio

| Sample | Na | Mn | Li | Ti/Si |
|---|---|---|---|---|
| Target Ratio | 0.72 | 0.755/0.74 | 0.24 | 0.005/0.02 |
| 0.5Si | 0.646 | 0.769 | 0.231 | 0.00404 |
| 2Si | 0.652 | 0.771 | 0.229 | 0.02712 |
| 0.5Ti | 0.632 | 0.773 | 0.227 | 0.00401 |
| 2Ti | 0.656 | 0.768 | 0.232 | 0.01855 |

In an example configuration, Ti and Si doped sodium ion cathode material is presented. In one configuration, a cathode material compound for a secondary Na-ion battery includes a sintered, granular mixture consisting of:
0.72 moles Na;
0.75 moles Mn;
0.24 moles Li; and
0.01 moles Ti or Si.
   P2-Na_{0.72}Mn_{0.76}Li_{0.24}O₂ (PR) was synthesized by facile solid-state reaction where the stoichiometric ratio of Na₂CO₃ (VWR, 99.5%), Mn₂O₃ (SIGMA-ALDRICH®, 99.9%) and LiOH·H₂O (Sigma-Aldrich, ≥98.0%) powders were thoroughly mixed in agate mortar and pestle. The mixed powder was then sintered at 800° C. for 14 hours under air atmosphere with heating and cooling rate of 2° C. min⁻¹. Likewise, the Ti/Si samples were prepared by adding 1 mol % TiO₂ (Sigma-Aldrich, 99.7%) or SiO₂ (ALFA AESAR®) as Ti and Si source, respectively, and followed the same sintering condition as PR. The final products were denoted as 1Ti and 1Si for P2-Na_{0.72}Mn_{0.75}Li_{0.24}Ti_{0.01}O₂ and P2-Na_{0.72}Mn_{0.75}Li_{0.24}Si_{0.01}O₂, respectively. Note that 0.5 mol % Si (0.5Si), 0.5 mol % Ti (0.5Ti), 2 mol % Si (2Si), and 2 mol % Ti (2Ti) were also prepared by the same means to explore the optimized composition.

Structural, morphological, and elemental distribution analysis were examined by X-ray diffraction (XRD; PANalytical Empyrean, Cu Kα target) and scanning electron microscopy coupled with energy dispersive X-ray spectroscopy. The FullProf Suite program was used for acquiring crystallinity information with Na_{0.67}Li_{0.17}Mn_{0.83}O₂ as a reference pattern (ICSD No. 04-020-1867). To confirm the molar ratio, inductively coupled plasma mass spectrometry (ICP-MS) was performed for the as-prepared samples. For post-mortem analysis, the electrodes were disassembled in an Argon-filled glovebox, rinsed with dimethyl carbonate (DMC) and dried in the glovebox prior to the XPS (X-ray Photoelectron Spectroscopy) and TEM (Transmission Electron Microscopy) characterization. The surface information of pristine powders and cycled electrodes were studied by X-ray photoelectron spectroscopy (XPS; PHI 5000 VersaProbe II) under the following testing conditions; 100-11 m beam (25 W) with Al Kα radiation (hυ=1486.6 eV), Ar⁺-ion and electron beam sample neutralization, fixed analyzer transmission mode, and pass energy of 23.5 eV. The XPS spectra was processed using XPSpeak41 software. The depth analysis of cycled electrodes was prepared via Ar⁺-sputtering from the electrode surface for 1 minute. Note that all the spectra were calibrated according to peak position of C is (284.8 eV). The HRTEM of the pristine and cycled electrodes was analyzed at the Argonne Chromatic Aberration-corrected TEM (ACAT, a FEI Titan 80-300 transmission electron microscope equipped with an image corrector to correct both spherical and chromatic aberrations). Electron energy-loss spectroscopy (EELS) was acquired using the ACAT operated at 200 KV in an image-coupled S/TEM mode. TEM specimens were prepared using Ar⁺ ion milling with an accelerating voltage of 4 kV followed by an ion milling polishing process with an accelerating voltage of 0.3 kV. Note that the cycled electrodes were thoroughly washed with dimethyl carbonate (DMC) and dried in a glove box prior to performing the post-mortem analysis.

The half-cells were assembled in Argon-filled glovebox (<0.1 ppm of O₂ and H₂O) with cathode, Na metal as the anode, glass microfiber separator (Whatman GF/D), and 1.0 M NaPF₆ in ethylene carbonate (EC) and diethyl carbonate (DEC) (2:3 in volume) with 5 vol % of fluoroethylene carbonate (FEC) as electrolyte. The 12-mm electrodes were composed of active cathode materials, super C65 carbon black and polyvinylidene fluoride (PVDF) in a weight ratio of 8:1:1. The active material loading was 3.0±0.5 mg cm⁻². The cells were tested with Land Battery Testing System (LAND CT2001A) between 1.5-4.5 V vs. Na/Na⁺ (1 C=200 mAh g⁻¹). For full-cell testing, the voltage window was set between 1.4-4.2 V with the activation cycle at 0.1 C and 0.5 C in the subsequent cycles. The capacity ratio for the anode to the cathode (N/P ratio) was controlled to 1.4-1.5:1.0. Hard carbon (MSE Supplies LLC) was used as the anode with weight ratio of 8:1:1 (active material: super C65: PVDF). The hard carbon (HC) was dried at 120° C. prior to use. To minimize the low coulombic efficiency in the first cycle of HC (due to irreversibility of Na), the HC electrode was activated by forming half-cell with Na metal and cycling at 0.1 C for 3 cycles between 0.01-2.0 V (vs. Na/Na⁺). Then, the half-cell was disassembled when fully charge to 2.0 V. Electrochemical impedance spectroscopy (EIS) and cyclic voltammetry (CV) data were collected using galvanostatic analyzer (Bio-Logic SAS VMP3). For EIS analysis, the frequency range and amplitude were 10 mHz-100 kHz and 10 mV, respectively. For CV analysis, the scanning rate of 0.1 mV s⁻¹ was applied between 1.5-4.5 V (vs. Na/Na⁺). Cell testing was performed at room temperature.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of forming a sodium-ion (NIB) battery comprising:
determining a stoichiometric ratio of sodium, manganese and lithium for a battery cathode;
combining and agitating the sodium, manganese and lithium to form a granular mixture in the determined stoichiometric ratio;
adding a doping element to the granular mixture; and
sintering the granular mixture for a predetermined time and temperature for forming a cathode material.

2. The method of claim 1 wherein the doping element includes Ti or Si.

3. The method of claim 1 wherein sintering includes heating at between 700° C. and 900° C. for between 12-16 hours.

4. The method of claim 1 wherein the cathode material exhibits two sodium ions in prismatic sites for forming a P2 layered oxide structure.

5. The method of claim 1 further comprising adding an amount of the doping element in a quantity less than 10% the molar ratio of any of the sodium, manganese and lithium.

6. The method of claim 5 further comprising adding an amount of the doping element in a quantity less than 10% the molar ratio of any of the sodium, manganese and lithium.

7. The method of claim 6 wherein the amount of the doping element is equal to or less than 2% the molar ratio of any of the sodium, manganese and lithium.

8. The method of claim 1 wherein the sodium, manganese and lithium further comprises Na₂CO₃, Mn₂O₃ and LiOH·H₂O.

9. The method of claim 1 wherein the stoichiometric ratio includes a molar quantity of both sodium and manganese at least twice the molar ratio of lithium.

10. The method of claim 9 wherein the stoichiometric ratio includes an equal molar quantity of both sodium and manganese, the molar quantity of sodium and manganese at least three times the molar quantity of lithium.

11. The method of claim 1 wherein the sodium, manganese and lithium are at least 98% pure.

12. The method of claim 5 wherein the doping element includes Ti or Si in a molar quantity less than 5% of the molar quantity of Li.

13. The method of claim 5 wherein the doping element includes Ti or Si in a molar quantity less than 2% of the molar quantity of nickel and manganese.

14. A cathode material compound for a secondary Na-ion battery, comprising:
a sintered, granular mixture consisting of:
0.72 moles Na;
0.75 moles Mn;
0.24 moles Li; and
0.01 moles Ti or Si.

15. A method for forming a P2 Na-ion battery cathode material, comprising:
mixing and agitating a stoichiometric ratio of cathode material elements including:
0.72 moles Na;
0.75 moles Mn;
0.24 moles Li; and
0.01 moles Ti or Si; and
sintering the mixed and agitated cathode material elements at 800° C. for 14 hours to result in active cathode material for a battery.

16. The method of claim 15 further comprising:
heating and cooling the agitated cathode material elements at 2° C. per minute.
